(19) United States
(12) Patent Application Publication
(10) Pub. No.: US 2009/0097648 A1
(43) Pub. Date: Apr. 16, 2009

(54) CONTENT SERVICE PROVIDING METHOD AND AUTHENTICATION METHOD BETWEEN DEVICES USING BROADCAST ENCRYPTION, DISPLAY DEVICE, AND RESOURCE-CONSTRAINED DEVICE

(75) Inventors: Bae Eun JUNG, Seongnam-si (KR); Maeng Hee SUNG, Seoul (KR); Hee Jean KIM, Yongin-si (KR); Nam Guk KIM, Seoul (KR); Tae Chul JUNG, Seongnam-si (KR)

Correspondence Address: DLA PIPER LLP US, P. O. BOX 2758, RESTON, VA, 20195, US

(73) Assignee: SAMSUNG ELECTRONICS CO., LTD., Suwon-si (KR)

(21) Appl. No.: 12/038,907

(22) Filed: Feb. 28, 2008

(30) Foreign Application Priority Data
Oct. 12, 2007 (KR) 10-2007-0103200

(51) Int. Cl. H04L 9/00

(52) U.S. Cl. 380/255

(57) ABSTRACT

A method of providing a content service and an authentication method between devices using broadcast encryption, a display device, and a resource-constrained device are provided. A method of providing a content service, the method including: transmitting, to a display device, an identification (ID) of a resource-constrained device via the resource-constrained device; receiving encryption information from the display device via the resource-constrained device; and decrypting the encryption information by using a stored secret key set via the resource-constrained device.

### CROSS-REFERENCE TO RELATED APPLICATION

This application claims the benefit under 35 U.S.C. § 119(a) of a Korean Patent Application No. 10-2007-0103200, filed on Oct. 12, 2007 in the Korean Intellectual Property Office, the entire disclosure of which is hereby incorporated by reference.

### BACKGROUND OF THE INVENTION

1. Field of the Invention

The present invention relates to a method of providing a content service and an authentication method between devices using broadcast encryption, a display device, and a resource-constrained device.

2. Description of Related Art

In order to protect paid contents, a service provider encrypts and transmits contents when providing at least one of an audio service and an image service of a video. Also, a content key used for encrypting the contents is encrypted using a key stored by a device and is transmitted so that a user device displaying the contents may perform decryption. The above-described paid content service includes a paid broadcast, a Digital Rights Management (DRM) system, and the like. Since DRM is an on-demand type providing a service when a user requires the service, a content key encrypted by only a user key is transmitted, however, encrypting the content key by using different keys for each user and transmitting the content key are impossible due to a large amount of transmission in a broadcast environment of simultaneously transmitting services to a plurality of members.

Recently, the contents are protected in the paid broadcast, and when a membership is revoked or a key of a display device is exposed, a requirement of discarding the key is shown. Also, a broadcast encryption algorithm is proposed for a solution to the requirement, and a standard and the like are enacted.

Accordingly, there is a need for a method of providing a content service and an authentication method between devices using broadcast encryption, a display device, and a resource-constrained device.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method of providing a content service which can protect contents and not provide the content service to a user whose service membership has been revoked or discard a key by extracting encryption information included in a Media Key Block (MKB) based on a revocation list and an identification (ID) of a resource-constrained device via a display device, and enabling the contents to be displayed when the resource-constrained device acquires a key corresponding to the contents by using a secret key.

An aspect of exemplary embodiments of the present invention also provides an authentication method between devices which can acquire a key necessary for authentication and perform the authentication between devices by acquiring encryption information based on a revocation list and an ID of a resource-constrained device via a display device, and decrypting the encryption information by using a portion of a secret key set via the resource-constrained device.

An aspect of exemplary embodiments of the present invention also provides a display device and a resource-constrained device used for at least one of a method of providing a content service and an authentication method between devices.

According to an aspect of exemplary embodiments of the present invention, there is provided a method of providing a content service, the method including: transmitting, to a display device, an ID of a resource-constrained device via the resource-constrained device, receiving encryption information from the display device via the resource-constrained device, and decrypting the encryption information by using a stored secret key set via the resource-constrained device.

In an exemplary implementation, the encryption information includes at least one of encrypted key information and a key tag.

In an exemplary implementation, the decrypting includes: decrypting encrypted key information included in the encryption information by using a secret key of the secret key set, the secret key corresponding to a key tag in the encryption information.

According to another aspect of exemplary embodiments of the present invention, there is provided a method of providing a content service, the method including: receiving first encryption information from a server via a display device, receiving an ID from a resource-constrained device via the display device, and extracting second encryption information by using the first encryption information and the ID and transmitting the second encryption information to the resource-constrained device via the display device.

According to still another aspect of exemplary embodiments of the present invention, there is provided an authentication method between devices, the method including: transmitting, to a display device, an ID of a resource-constrained device, extracting encryption information from an MKB by using a revocation list and the ID and transmitting the encryption information to the resource-constrained device via the display device, and decrypting the encryption information by using a portion of a secret key set and acquiring a corresponding key via the resource-constrained device.

According to yet another aspect of exemplary embodiments of the present invention, there is provided a display device including: a first encryption information receiver for receiving first encryption information from a server, an ID receiver for receiving an ID from a resource-constrained device, and a second encryption information processor for extracting second encryption information by using the first encryption information and the ID, and transmitting the second encryption information to the resource-constrained device.

According to a further aspect of exemplary embodiments of the present invention, there is provided a resource-constrained device including: an ID transmitter for transmitting an ID to a display device, an encryption information receiver for receiving encryption information from the display device, and a decrypter for decrypting the encryption information by using a secret key set.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following detailed description, taken in conjunction with the accompanying drawings in which:

FIG. 1 illustrates an overview of a method of providing a content service according to an exemplary embodiment of the present invention;

FIG. 2 is a flowchart illustrating a method of providing a content service according to an exemplary embodiment of the present invention;

FIG. 3 is flowchart illustrating a method of providing a content service according to another exemplary embodiment of the present invention;

FIG. 4 illustrates an overview of an authentication method between devices according to an exemplary embodiment of the present invention;

FIG. 5 is flowchart illustrating an authentication method between devices according to an exemplary embodiment of the present invention;

FIG. 6 is a block diagram illustrating an internal configuration of a display device according to an exemplary embodiment of the present invention; and

FIG. 7 is a block diagram illustrating an internal configuration of a resource-constrained device according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

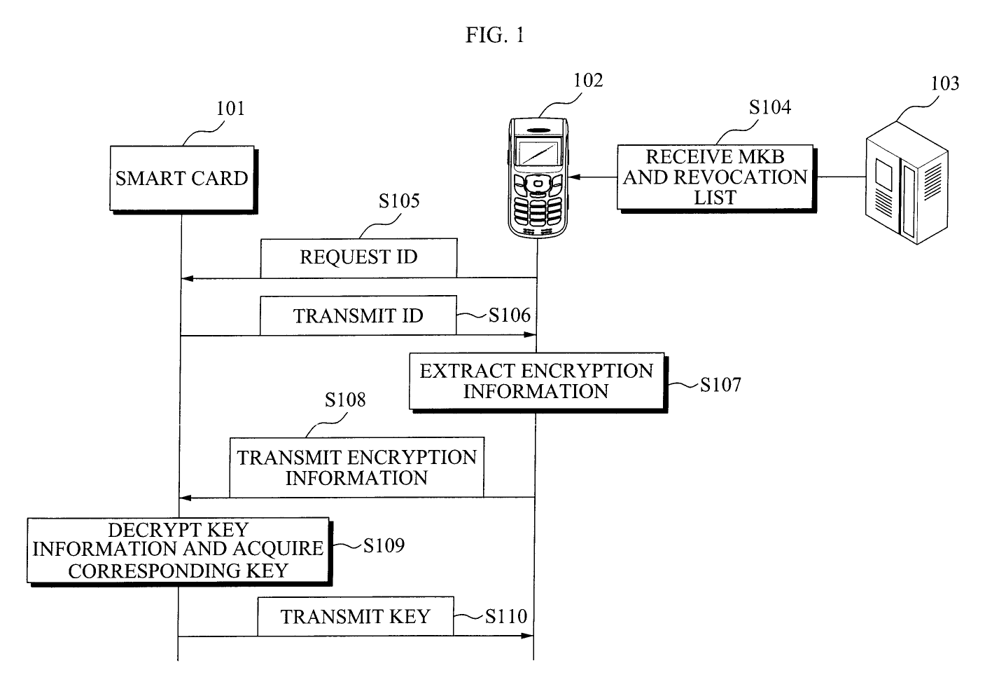

FIG. 1 illustrates an overview of a method of providing a content service according to an exemplary embodiment of the present invention. Here, FIG. 1 illustrates a communication procedure between a smart card 101 and a display device 102 available for networking. Here, the smart card 101 is used as an example of a resource-constrained device.

Referring to FIG. 1, the display device 102 according to an exemplary implementation of the present invention receives, from a server 103, a Media Key Block (MKB) encrypting a key corresponding to contents and a revocation list in step S104, and requests the smart card 101 for an identification (ID) in step S105. The smart card 101 is a device for decrypting the corresponding key.

The smart card 101 transmits ID information of the smart card 101 to the display device 102 in step S106, and the display device 102 extracts encryption information corresponding to the smart card 101 from among information included in the MKB by using the MKB received from the server 103, the revocation list, and the ID received from the smart card 101 in step S107, and transmits the extracted encryption information to the smart card 101 in step S108. In an exemplary implementation, the encryption information includes encrypted key information for the key corresponding to the contents, and a key tag. Specifically, the encryption information extracted from the MKB based on the revocation list and the ID via the display device 102 may include the encrypted key information being information decryptable via a secret key included in the smart card 101, and the key tag used for selecting the secret key.

The smart card 101 may verify the secret key corresponding to the key tag in a secret key set being a set of secret keys stored in the smart card 101, decrypt the encrypted key information using the secret key, and acquire the key corresponding to the contents in step S109. Subsequently, the smart card 101 enables a user to use a service by transmitting the corresponding key to the display device 102 via a secure channel in step S110.

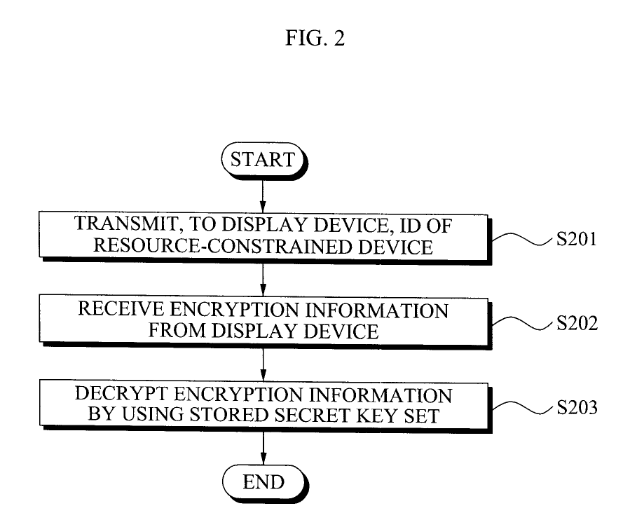

FIG. 2 is a flowchart illustrating a method of providing a content service according to an exemplary embodiment of the present invention. FIG. 2 illustrates an example for describing operations of a resource-constrained device in a method of providing a content service by using a broadcast encryption algorithm in a system including a server, a display device, and the resource-constrained device.

In step S201, the resource-constrained device transmits, to a display device, an ID of the resource-constrained device. In an exemplary implementation, the resource-constrained device may transmit the ID to the display device according to a request for the ID from the display device.

In step S202, the resource-constrained device receives encryption information from the display device. The display device receives an MKB and a revocation list from the server, and stores the MKB and the revocation list. Also, the display device may extract the encryption information from the MKB based on the ID and the revocation list, and transmit the encryption information to the resource-constrained device. In an exemplary implementation, the encryption information includes encrypted key information and a key tag, and the encrypted key information includes encrypted information of a key corresponding to contents. Specifically, the resource-constrained device may acquire the encrypted key information and the key tag by receiving the encryption information transmitted from the display device.

In step S203, the resource-constrained device decrypts the encryption information by using a stored secret key set. In an exemplary implementation, the resource-constrained device may search for a corresponding secret key of the secret key set using the key tag in the encryption information, and decrypt the encrypted key information included in the encryption information using the secret key.

A user device such as the resource-constrained device may include the secret key set including various secret keys. In an exemplary implementation, when the broadcast encryption algorithm to be initially used is designed and embodied in a user device, the user device determines how to configure a user group, and a tree type is used as an example of representative methods. Specifically, the secret keys corresponding to each layer of the tree may be allocated, and the user device may allocate the secret key set corresponding to a path of the user device.

Here, an authorized user device may not use secret keys included in the same group as a group of the discarded user device, and a key header may be configured to calculate the key corresponding to the contents by using the undiscarded secret key. In an exemplary implementation, the user device may include the secret key set including at least one secret key. However, a memory of a smart card, a Radio Frequency Identification (RFID) tag, and the like is limited in connecting between the key tag classifying each secret key and the secret key set, and storing the key tag and the secret key set, and a limit of a storage capability may be generated. Accordingly, the method of providing the content service according to an exemplary implementation of the present invention stores only the secret key set in the resource-constrained device as described above, and uses the key tag received from the display device. Therefore, the broadcast encryption algorithm may be easily applied to a resource-constrained user device.

As described above, the resource-constrained device may acquire the key for using the contents in step S201 through step S203. The resource-constrained device enables the user to use the service for the contents via the display device by subsequently transmitting the key to the display device via a secure channel such as an authenticated secret channel.

Also, the display device may display the contents when the display device includes the key corresponding to the contents, however, according to an exemplary implementation of the present invention, since the user acquires the key corresponding to the contents via the portable resource-constrained device and transmits the key to the display device, the user may use the service for the contents via the desired display device when the user possesses the resource-constrained device such as the smart card and the RFID tag regardless of the display device.

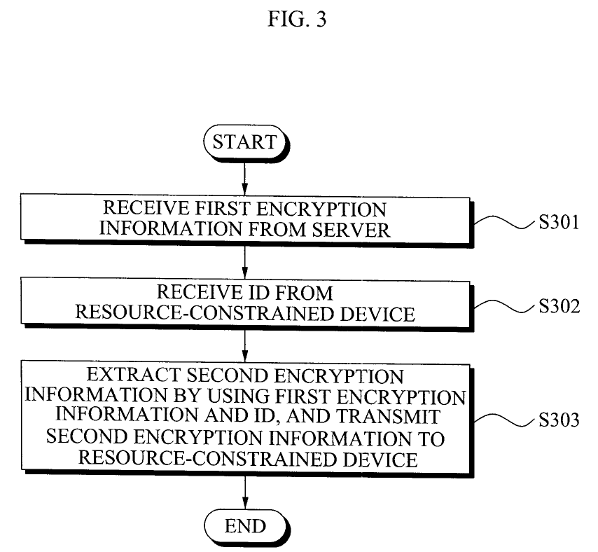

FIG. 3 is flowchart illustrating a method of providing a content service according to another exemplary embodiment of the present invention. FIG. 3 illustrates an example for describing operations of a display device in a method of providing a content service by using a broadcast encryption algorithm in a system including a server, a display device, and the resource-constrained device.

In step S301, the display device receives first encryption information from a server. In an exemplary implementation, the first encryption information includes an MKB and a revocation list described with reference to FIG. 1 and FIG. 2.

In step S302, the display device receives an ID from a resource-constrained device. The ID is an ID of the resource-constrained device, and the resource-constrained device may transmit the ID to the display device according to an ID request from the display device.

In step S303, the display device extracts second encryption information by using the first encryption information and the ID, and transmits the second encryption information to the resource-constrained device. In an exemplary implementation, the display device extracts the second encryption information from the MKB by using the revocation list included in the first encryption information and the ID, and transmits the second encryption information to the resource-constrained device. Here, the second encryption information includes encrypted key information including encrypted information of the key corresponding to the contents, and the key tag for searching for the secret key of the secret key set included in the resource-constrained device, the secret key to be used. Specifically, the second encryption information includes information identical to the encryption information described with reference to FIG. 2.

The resource-constrained device may acquire the key by searching for the secret key corresponding to the key tag and decrypting the key information, and enables the user to use the service for the contents via the display device by transmitting the key to the display device.

As described above, according to an exemplary implementation of the present invention, since the display device may acquire the key corresponding to the contents via the resource-constrained device, the user may use the service for the contents via the display device by simply possessing the resource-constrained device. Also, since the display device may determine whether the resource-constrained device is authorized by using the revocation list, the display device does not transmit the second encryption information to the resource-constrained device when the service for the user of the resource-constrained device is revoked. Accordingly, the service is not provided for the user whose membership of the service is revoked.

The broadcast encryption algorithm has features that revocation is possible for each device without using a public key, and that the key is shared with many and unspecified persons. Accordingly, the broadcast encryption algorithm is available as an authentication algorithm between devices.

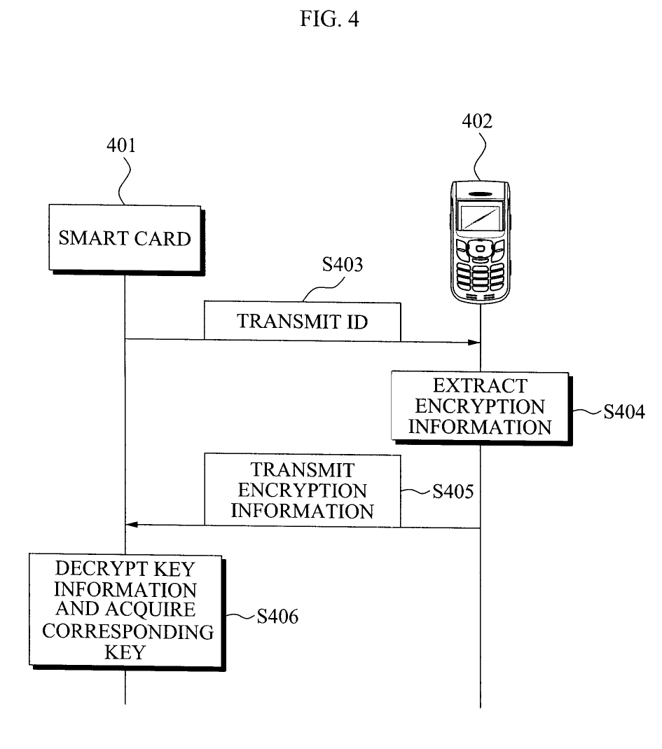

FIG. 4 illustrates an overview of an authentication method between devices according to an exemplary embodiment of the present invention. Here, FIG. 4 illustrates an authentication method between a smart card 401 and a display device 402.

The display device 402 stores an MKB and a revocation list, and the smart card 401 stores a valid secret key extracting specific key information from the MKB. In an exemplary implementation, in operation S403, when the smart card 401 transmits an ID of the smart card 401 to the display device 402, in operation S404, the display device 402 may extract encryption information necessary for the smart card 401 from the MKB using the revocation list and the ID, and in operation S405, transmit the encryption information to the smart card 401. In an exemplary implementation, in operation S406, the encryption information may include encrypted key information and a key tag corresponding to the ID. Specifically, the smart card 401 may decrypt the encrypted key information by using a secret key of a secret key set of the smart card 401, the secret key corresponding to the key tag. Accordingly, the specific key may be extracted, and authentication between the smart card 401 and the display device 402 may be performed using the specific key.

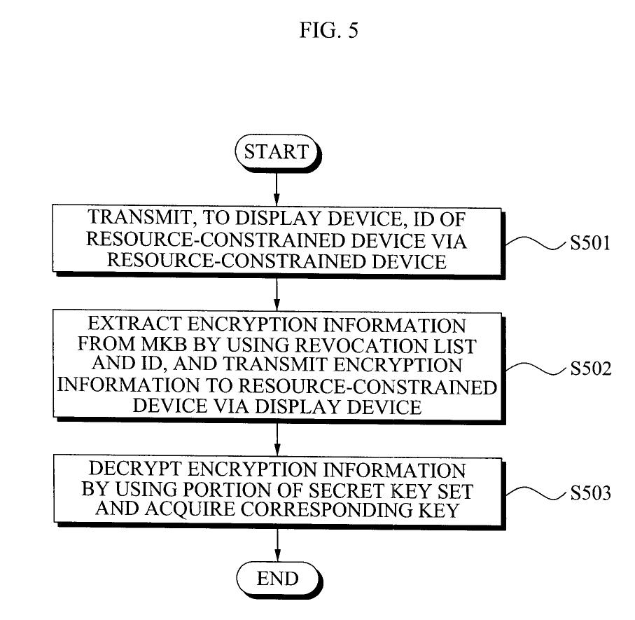

FIG. 5 is flowchart illustrating an authentication method between devices according to an exemplary embodiment of the present invention. Here, FIG. 5 illustrates an example for describing an authentication method between devices by using a broadcast encryption algorithm in a system including a display device and a resource-constrained device.

In step S501, the resource-constrained device transmits, to a display device, an ID of the resource-constrained device via the resource-constrained device.

In step S502, the display device extracts encryption information from an MKB by using a revocation list and the ID, and transmits the encryption information to the resource-constrained device via the resource-constrained device. Here, the encryption information includes at least one of encrypted key information and a key tag.

In an exemplary implementation, the display device may first determine whether the resource-constrained device is authorized by using the revocation list. For example, whether revocation of the resource-constrained device is performed may be verified by searching for the revocation list using the ID of the resource-constrained device, and when the revocation of the resource-constrained device is performed, the encryption information may not be transmitted to the resource-constrained device.

In step S503, the resource-constrained device decrypts the encryption information by using a portion of a secret key set and acquires a corresponding key. In an exemplary implementation, the resource-constrained device may acquire the key by decrypting encrypted key information included in the encryption information using a secret key of the secret key set, the secret key corresponding to a key tag in the encryption information. Specifically, the resource-constrained device and the display device may ultimately perform authentication between the resource-constrained device and the display device using the key.

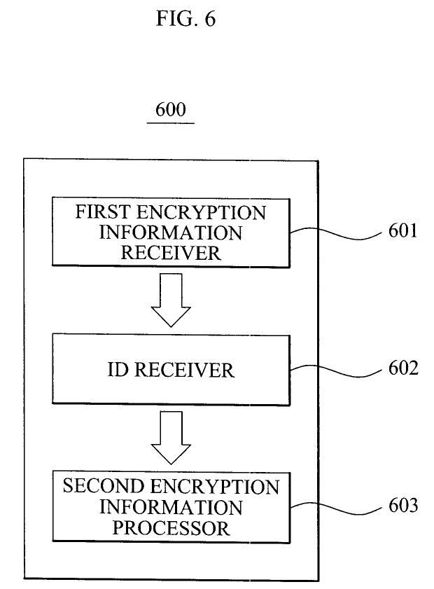

FIG. 6 is a block diagram illustrating an internal configuration of a display device 600 according to an exemplary embodiment of the present invention.

According to an exemplary implementation of the present invention, the display device 600 includes a first encryption information receiver 601, an ID receiver 602, and a second encryption information processor 603.

The first encryption information receiver 601 receives first encryption information from a server. In an exemplary implementation, the first encryption information includes an MKB and a revocation list.

The ID receiver 602 receives an ID from a resource-constrained device. The ID is an ID of the resource-constrained device, and the resource-constrained device may transmit the ID to the ID receiver 602 according to an ID request from the display device 600.

The second encryption information processor 603 extracts second encryption information by using the first encryption information and the ID, and transmits the second encryption information to the resource-constrained device. In an exemplary implementation, the second encryption information processor 603 extracts the second encryption information from the MKB by using the revocation list included in the first encryption information and the ID, and transmits the second encryption information to the resource-constrained device. Here, the second encryption information includes encrypted key information including encrypted information of the key corresponding to the contents, and the key tag for searching for the secret key of the secret key set included in the resource-constrained device, the secret key to be used.

The resource-constrained device may acquire the key by searching for the secret key corresponding to the key tag and decrypting the key information, and enables the user to use the service for the contents via the display device 600 by transmitting the key to the display device 600.

As described above, according to an exemplary implementation of the present invention, since the display device may acquire the key corresponding to the contents via the resource-constrained device, the user may use the service for the contents via the display device by simply possessing the resource-constrained device. Also, since the display device may determine whether the resource-constrained device is authorized by using the revocation list, the display device does not transmit the second encryption information to the resource-constrained device when the service for the user of the resource-constrained device is revoked. Accordingly, the service is not provided for the user whose membership of the service is revoked.

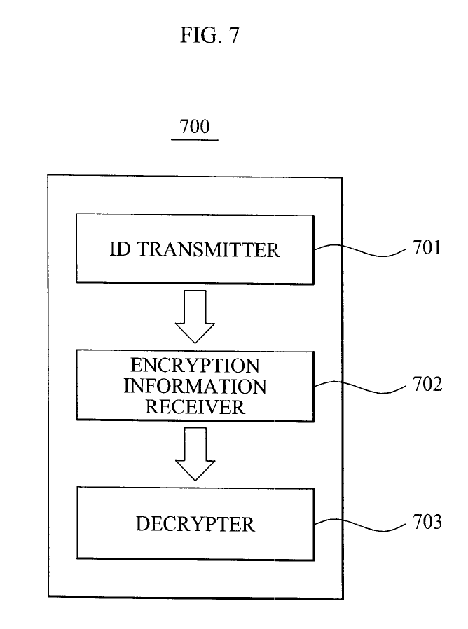

FIG. 7 is a block diagram illustrating an internal configuration of a resource-constrained device 700 according to an exemplary embodiment of the present invention.

Here, according to an exemplary implementation of the present invention, the resource-constrained device 700 includes an ID transmitter 701, an encryption information receiver 702, and a decrypter 703.

The ID transmitter 701 transmits an ID of the resource-constrained device 700 to a display device. In an exemplary implementation, the resource-constrained device may transmit the ID to the display device according to an ID request from the display device.

The encryption information receiver 702 receives encryption information from the display device. Here, the encryption information includes information identical to the second encryption information described with reference to FIG. 6. Specifically, the display device stores the MKB and the revocation list received from the server, extracts the encryption information from the MKB based on the ID and the revocation list, and transmits the encryption information to the resource-constrained device. In an exemplary implementation, the encryption information includes encrypted key information and a key tag, and the encrypted key information includes encrypted information of a key corresponding to contents. Specifically, the encryption information receiver 702 may acquire the encrypted key information and the key tag by receiving the encryption information transmitted from the display device.

The decrypter 703 decrypts the encryption information by using a stored secret key set. In an exemplary implementation, the decrypter 703 may acquire the key corresponding to the contents by searching for a corresponding secret key of the secret key set using the key tag in the encryption information, and decrypting the encrypted key information included in the encryption information using the secret key.

As described above, the resource-constrained device according to an exemplary implementation of the present invention stores only the secret key set, and uses the key tag received from the display device. Accordingly, the broadcast encryption algorithm may be easily applied to a resource-constrained user device.

Also, the resource-constrained device enables the user to use the service for the contents via the display device by transmitting the key to the display device via a secure channel such as an authenticated secret channel after acquiring the key for using the contents.

Also, the display device may display the contents when the display device includes the key corresponding to the contents, however, according to an exemplary implementation of the present invention, since the user acquires the key corresponding to the contents via the portable resource-constrained device and transmits the key to the display device, the user may use the service for the contents via the desired display device when the user possesses the resource-constrained device such as the smart card and the RFID tag regardless of the display device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. Therefore, it is intended that the scope of the invention be defined by the claims appended thereto and their equivalents.

While the invention has shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method of providing a content service, the method comprising:
transmitting, to a display device, an identification (ID) of a resource-constrained device via the resource-constrained device;
receiving encryption information from the display device via the resource-constrained device; and
decrypting the encryption information by using a stored secret key set via the resource-constrained device.

2. The method of claim 1, wherein the encryption information includes at least one of encrypted key information and a key tag.

3. The method of claim 1, wherein the decrypting comprises:
decrypting encrypted key information included in the encryption information by using a secret key of the secret key set, the secret key corresponding to a key tag in the encryption information.

4. A method of providing a content service, the method comprising:
receiving first encryption information from a server via a display device;
receiving an ID from a resource-constrained device via the display device; and
extracting second encryption information by using the first encryption information and the ID and transmitting the second encryption information to the resource-constrained device via the display device.

5. The method of claim 4, wherein the first encryption information includes at least one of a Media Key Block (MKB) and a. revocation list.

6. The method of claim 4, wherein the extracting and transmitting comprises:
extracting the second encryption information from an MKB included in the first encryption information by using a revocation list included in the first encryption information and the ID.

7. The method of claim 4, wherein the second encryption information includes at least one of encrypted key information and a key tag.

8. An authentication method between devices, the method comprising:
transmitting, to a display device, an ID of a resource-constrained device;
extracting encryption information from an MKB by using a revocation list and the ID and transmitting the encryption information to the resource-constrained device via the display device; and
decrypting the encryption information by using a portion of a secret key set and acquiring a corresponding key via the resource-constrained device.

9. The method of claim 8, wherein the encryption information includes at least one of encrypted key information and a key tag.

10. The method of claim 8, wherein the decrypting and acquiring comprises:
decrypting encrypted key information included in the encryption information by using a secret key of the secret key set, the secret key corresponding to a key tag in the encryption information.

11. A display device comprising:
a first encryption information receiver for receiving first encryption information from a server;
an ID receiver for receiving an ID from a resource-constrained device; and
a second encryption information processor for extracting second encryption information by using the first encryption information and the ID, and transmitting the second encryption information to the resource-constrained device.

12. The device of claim 11, wherein the first encryption information includes at least one of an MKB and a revocation list.

13. The device of claim 11, wherein the second encryption information includes at least one of encrypted key information and a key tag.

14. A resource-constrained device comprising:
an ID transmitter for transmitting an ID to a display device;
an encryption information receiver for receiving encryption information from the display device; and
a decrypter for decrypting the encryption information by using a secret key set.

15. The device of claim 14, wherein the encryption information includes at least one of encrypted key information and a key tag.

16. The device of claim 14, wherein the decrypter decrypts encrypted key information included in the encryption information by using a secret key of the secret key set, the secret key corresponding to a key tag in the encryption information.
